(19) United States
(12) Patent Application Publication
(10) Pub. No.: US 2013/0085958 A1
(43) Pub. Date: Apr. 4, 2013

(54) FLEXIBLE AND AUTOMATED PROCESSING OF ELECTRONIC DOCUMENTS

(71) Applicants: Oliver BECK, Stuttgart (DE); Frank BEUNINGS, Wiesloch (DE); Hans CHELNIAK, Hockenheim (DE)

(72) Inventors: Oliver BECK, Stuttgart (DE); Frank BEUNINGS, Wiesloch (DE); Hans CHELNIAK, Hockenheim (DE)

(73) Assignee: SAP AG, Walldorf (DE)

(21) Appl. No.: 13/285,669

(22) Filed: Oct. 31, 2011

Related U.S. Application Data
(60) Provisional application No. 61/541,792, filed on Sep. 30, 2011.

(51) Int. Cl. G06Q 10/00

(52) U.S. Cl. 705/342

(57) ABSTRACT

A system for processing electronic documents includes an existing business system (or systems) connected to a separate control system. The resulting composite system provides a framework that enables a flexible and customizable process definition for handling incoming documents. Within the process definition all the processing steps which are desired for handling an incoming electronic document can be predefined. Processing steps like checking the signature and authorizing an incoming legal document can be implemented in the control system and steps like posting a goods receipt or an invoice are implemented in one of the connected business systems. The content of the incoming document is evaluated to determine which business process may be used to carry out the necessary processing steps for the incoming electronic document. The assigned business process and a related process flow sequence define the processing steps to be implemented.

### CROSS REFERENCE TO RELATED APPLICATIONS

This application claims the benefit of U.S. Provisional Application No. 61/541,792, filed Sep. 30, 2011, the contents of which are incorporated herein by reference.

### BACKGROUND

Many businesses rely on enterprise resource planning (ERP) computing architectures to electronically manage and coordinate business resources, information, and functions. However, the processing of incoming legal documents continues to involve a substantial amount of manual work. The content of the legal documents must often be analyzed manually by a user in order to decide which steps have to be carried out in the ERP system to cover the business processes associated with the legal document. Afterwards the required processing steps, like posting a goods receipt or invoice receipt, would be executed using standard ERP system transactions. Furthermore, some of the data contained in the incoming legal documents may have to be entered manually into the ERP system to execute the postings accordingly.

For example, the Nota Fiscal eletrônica (NF-e) is a legal document and an electronic invoice which contains tax and logistical information in the form of an XML document with a layout defined by the Brazilian government. The NF-e can involve both Business to Government (B2G) communication (requesting authorization of NF-e from tax administration before billing may take place) as well as Business to Business (B2B) communication (sending the authorized NF-e to the customer).

In the B2B case for an incoming NF-e, the information provided in the document will lead to certain processing steps having to be performed. The reason is that in addition to the regular processing of Goods Receipts (GR) and Invoice Receipts (IR), the processing of the XML messages results in additional process steps that are necessary to carry out, e.g. checking authorization of NF-e with Government etc. Because these documents contain information which belongs to different categories of documents in the ERP system like purchase order, delivery, goods movement or invoice, they can be viewed as a combination of different ERP system documents representing a whole business process which can be automatically executed.

Therefore there is a need for flexible automated processing of electronic documents containing tax and logistical information by existing ERP systems.

### SUMMARY OF THE INVENTION

For the processing of electronic documents, an existing ERP system (or systems) can benefit from a connection to a separate Governance, Risk, and Compliance system, usually referred to as a GRC system. The goal of GRC is to help a company efficiently put policies and controls in place to address all its compliance obligations while at the same time gathering information that helps proactively run the business and assess potential risks. A GRC system can create a central nervous system that helps a company monitor compliance and manage their business risks more effectively. In this way a GRC system can help a company keep track of transactions and raise an alert when things go off track or when risks appear.

A system for processing electronic documents includes a framework that enables a flexible and customizable process definition for handling incoming documents. Within the process definition all the steps which are desired for handling an incoming document can be predefined. Some of the processing steps like checking the signature and authorization of an incoming legal document can be executed in the GRC system, some other steps like posting a goods receipt or posting an invoice are executed in one of the connected ERP systems. The content of the incoming document is evaluated to determine which business process may be used to carry out the necessary processing steps. To this end an incoming document is automatically analyzed to extract information regarding the relevant parameters evaluated to assign the business process. The assigned business process and a related process flow sequence define the processing steps to be executed.

The control of the execution of the processing steps is carried out in the GRC system. This is done using an extendable status concept for the processing flow so that a linear process where a follow on step always depends on the preceding step can be implemented as well as a more complex non linear process flow where a follow on step may depend on a subsequent step. The business process to be assigned, the process flow sequence and control can all be customized in a flexible manner and new processing steps can even be implemented. For example, the defined process flow sequence may be customized so that it varies depending on certain variables, such as the business partners involved in the assigned business process. If several ERP systems are assigned to one GRC system, the determination of the corresponding ERP system for an incoming document may be made based on the content of the document.

### BRIEF DESCRIPTION OF THE DRAWINGS

FIG. 1 shows an example system and processing flow according to the present invention.

FIG. 2 shows an example system according to the present invention.

FIG. 3 shows an example method according to the present invention.

FIG. 4 shows an example process flow execution according to the present invention.

FIG. 5 shows an example screenshot of a user interface according to the present invention.

FIG. 6 shows an example screenshot of a user interface according to the present invention.

### DETAILED DESCRIPTION

Embodiments of the present invention will now be described in detail, by way of example only, with reference to the accompanying drawings in which identical or corresponding parts/features are provided with the same reference numerals in the figures.

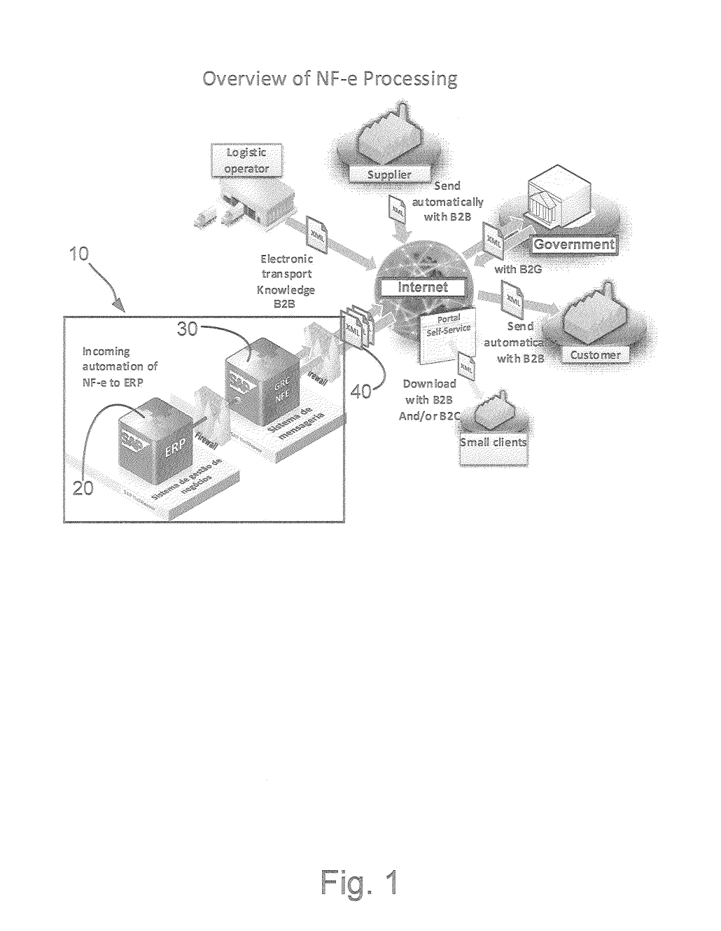

FIG. 1 shows the processing flow of electronic documents received by a system 10 for processing electronic documents. System 10 includes an existing business system (or systems), for example ERP system 20, that is connected to a separate control system, for example GRC (Governance, Risk management, and Compliance) system 30. Certain content 35 of an incoming electronic document, for example XML document 40, is extracted to determine which business process 45 is associated with the extracted content 35. When implementing the processing steps associated with the determined business process 45, some of the processing steps like checking the signature and authorization of an incoming legal document can be executed hi the GRC system 30, and other steps like posting a goods receipt or posting an invoice can be executed in connected ERP system 20.

XML document 40 can be, for example, a Nota Fiscal eletrônica (NF-e) which is a legal document and an electronic invoice which contains tax and logistical information in the form of an XML document with a layout defined by the Brazilian government, The NE-e can involve both Business to Government (B2G) communication (requesting authorization of NF-e from tax administration before billing may take place) as well as Business to Business/B2B) or Business to Customer (B2C) communication (sending the authorized NF-e to the customer). Because incoming electronic documents can contain information which requires processing steps like checking the signature and authorization of an incoming legal document that can be executed in the GRC system 30 and information which belongs to different categories of documents in the ERP system like purchase order, delivery, goods movement or invoice, they can be viewed as a combination of different GRC and ERP processes representing a larger business process which can be automatically executed.

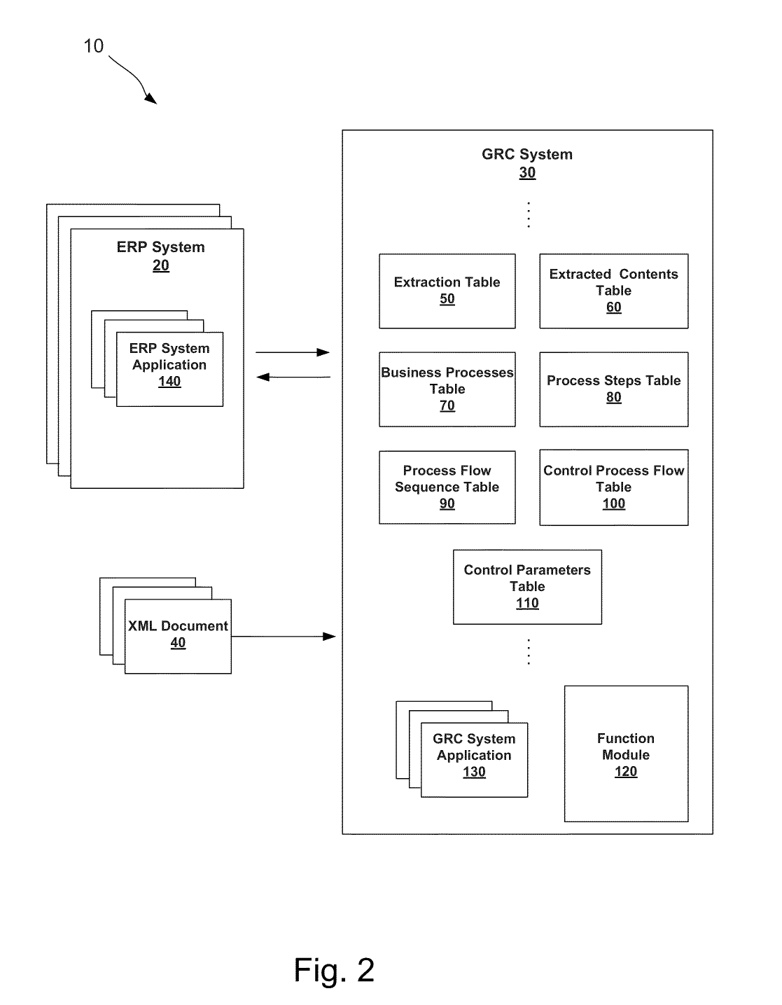

FIG. 2 shows example system 10 in further detail. As mentioned above, system 10 includes an existing business system (or systems), for example ERP system 20, that is connected to a separate control system, for example GRC system 30. Certain content 35 of an incoming electronic document, for example XML document 40, is extracted to determine which business process 45 is associated with the extracted content 35. GRC system 30 extracts content 35 from the at least one XML document 40 according to an extraction table 50 in the GRC system 30. The extraction table 50 defines the contents 35 to be extracted for each type of electronic document that is processed. GRC system 30 includes an extracted content table 60 which defines an associated business process 45 for each of the at least one extracted content 35 of the at least one XML document 40. Therefore a comparison of at least one of the extracted content 35 to the extracted content table 60 is performed in GRC system 30 to determine which business process 45 should be implemented.

For example, in the case of the Nota Fiscal eletrônica the business process determination depends mainly on the CFOP code which is defined by the Brazilian authorities and describes the type of business transaction. However, the meaning of a CFOP code can be changed by the authorities so that the system behavior has to be adjusted. This type of situation can be handled by the extracted content table 60 of GRC system 30, which can be customized so as to adjust the business process determination to changes of the meaning of the CFOP codes or any other extracted content 35.

The GRC system 30 includes a business processes table 70 which defines the processing steps 75 that need to be implemented for each of the business processes 45 that can be implemented by system 10. For example, the definition of the required processing steps 75 for possible business processes 45 like ‘Normal Purchasing’ or ‘Stock Transfer’ which would be implemented in the ERP system 20 or “Signature Authentication” that would be implemented in the GRC system. The business processes 45 can be categorized to be valid for certain document types. The definition and implementation of each of the processing steps 75 is contained in a process steps table 80 in the GRC system. The process steps table 80 defines certain attributes of each processing step 75, for example, if the step can be carried out automatically or also manually and if the step is optional or mandatory within the business process 45.

The GRC system 30 includes a process flow sequence table 90 which defines the sequence of processing steps 75 for a certain business process 45 and if each of the processing steps 75 are to be executed automatically or have been deactivated. The GRC system 30 also includes a control process flow table 100 which defines the prerequisites necessary before implementing each processing step 75 in each business process 45. Therefore with an extendable status concept this allows the control process flow table 100 to define which status of the preceding or subsequent steps are necessary to carry out a certain processing step 75 in a certain business process 45. This allows the implementation of a linear process flow where a follow on step always depends on the preceding step as well as a more complex non linear process flow.

A control parameters table 110 in GRC system 30 allows users to influence the processing steps 75. Depending on the definition of the processing step 75 in process steps table 80 and the at least one extracted content 35, for example the business partners involved in the business process 45, the execution of a processing step 75 can be defined as automatically or manually implemented or can be deactivated, for example for a certain combination of business partners. Therefore, control parameters table 110 allows users to overwrite the criteria defined in the process flow sequence table 90.

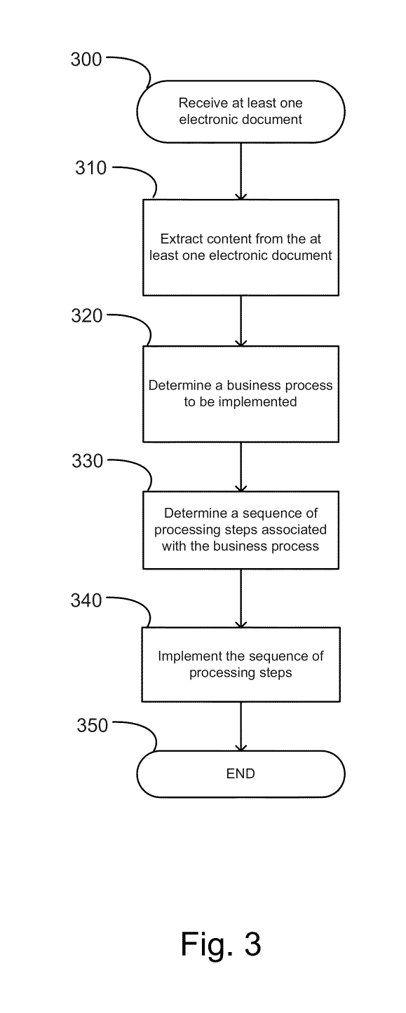

FIG. 3 shows an example embodiment of the method for processing electronic documents. In step 300 at least one electronic document, for example XML document 40, is received in GRC system 30. In step 310 GRC system 30 extracts contents 35 from the at least one XML document 40 according to an extraction table 50 in the GRC system 30. In step 320 the business process 45 associated with the at least one XML document 40 is determined by comparing the at least one extracted contents 35 to the extracted content table 60 in GRC system 30 to determine which business process 45 should be implemented. In step 330 the sequence of processing steps 75 associated with business process 45 is determined by comparing the determined business process 45 to business processes table 70 in GRC system 30 to determine which processing steps 75 need to be implemented for business process 45 and comparing the determined business process 45 to process flow sequence table 90 in GRC system 30 to determine the sequence of processing steps 75 for the determined business process 45. In step 340 the sequence of processing steps 75 associated with business process 45 is implemented in a function module 120 in GRC system 30, based on the definition of each processing step 75 in process steps table 80 in GRC system 30. The implementing of the sequence of processing steps 75 proceeds by comparing the status of each processing step 75 in the sequence of processing steps for business process 45 to pre-requisites for implementing a next processing step 75 in the sequence of processing steps for business process 45 as defined in control process flow table 100 in GRC system 30. In step 350 the method concludes.

As mentioned above the implementation of business process 45 is governed by a function module 120 which acts as the central engine responsible for execution and control of the business process flow.

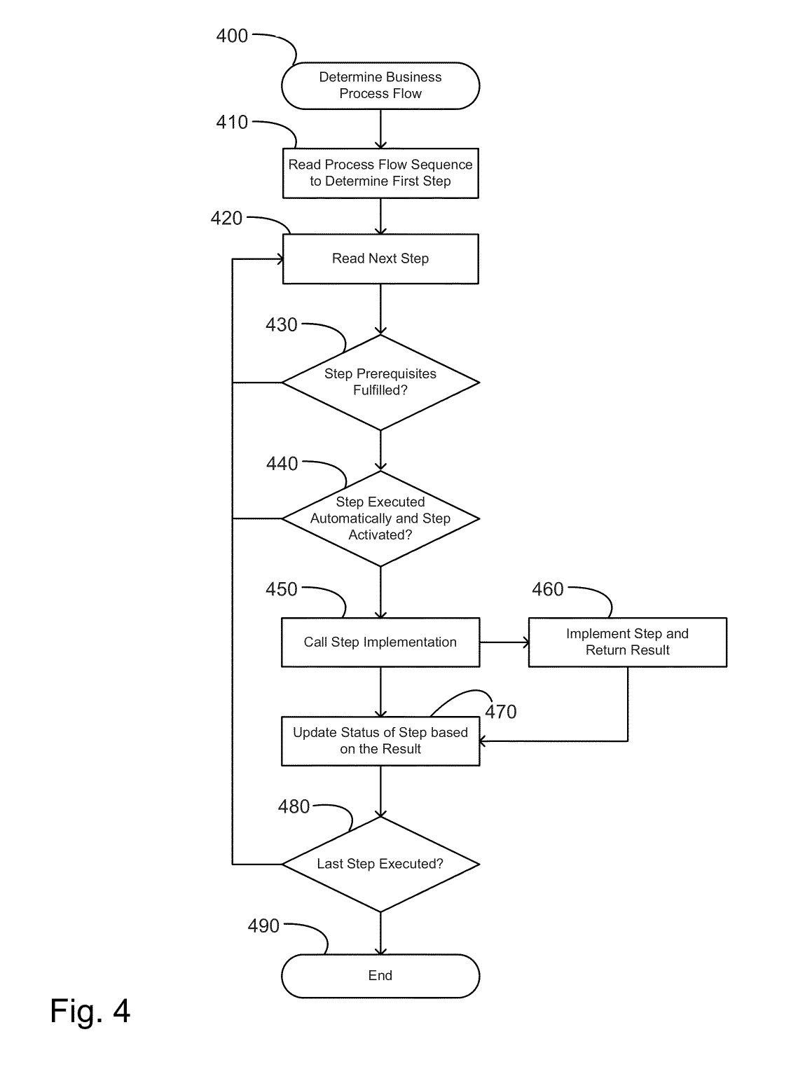

FIG. 4 shows an example embodiment of the business process flow as executed by function module 120. In step 400 the business process flow which is associated with the business process 45 assigned to the incoming electronic document, for example XML document 40, is determined. In step 410 the first processing step 75 to be implemented is determined by examining the process flow sequence table 90 for the business process 45 assigned to XML document 40. After the first processing step 75 to be implemented is determined, in step 420 a loop will be performed on the processing steps 75 beginning with the reading of the first step. In step 430 the prerequisites for the current processing step 75 are checked against the control process flow table 100 to evaluate the status of the prerequisites related to current processing step 75. In step 440 the attributes of the current processing step 75 are checked to determine if the step is implemented automatically and if the step is deactivated for XML document 40 which is currently being processed. This information is stored on document level as result of the combination of the settings in table process flow sequence table 90 and the control parameters table 110. If all prerequisites are fulfilled, the current processing step 75 implementation defined in process steps table 80 is called in step 450. In step 460 the current processing step 75 is implemented in GRC system 30 by a GRC system application 130 in function module 120 or it is implemented in ERP system 20 by an ERP system application 140. After the processing of the current processing step 75 the result will be stored on document level in step 470 and the status of the current processing step 75 will be updated. In step 480 the loop continues and an attempt is made to implement the next step if there is one. If no further processing is possible e.g. due to an error or the necessity of a user interaction the process stops in step 490 to be automatically continued at a later time.

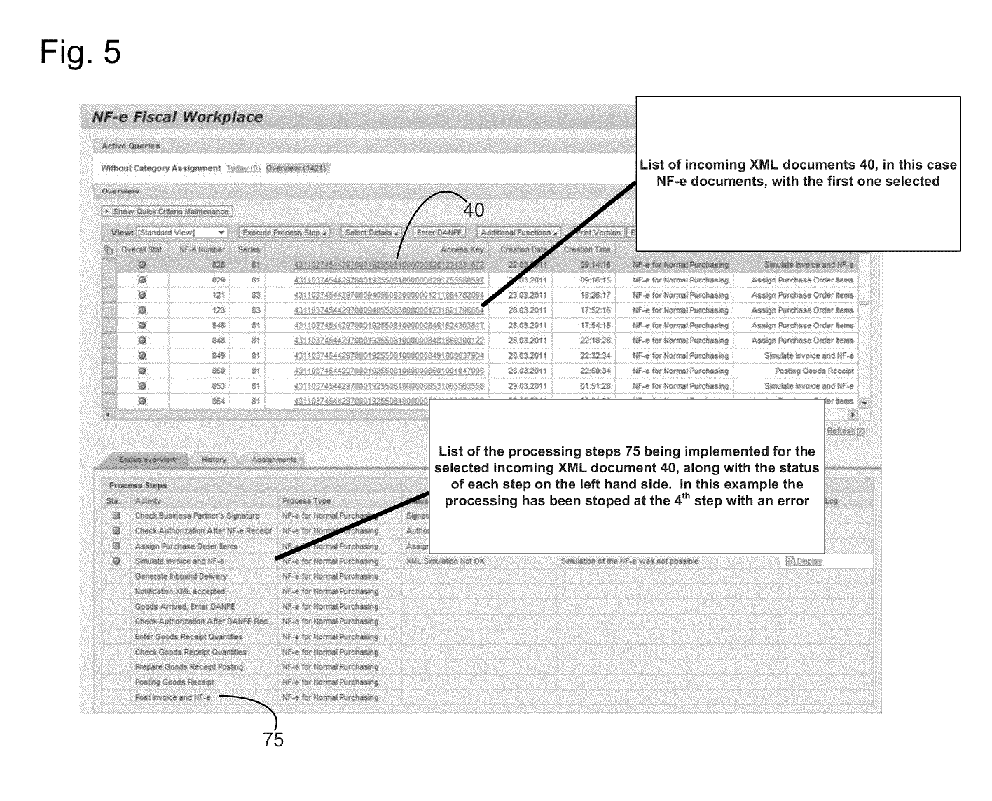

FIG. 5 shows an example user interface for the system 10 for processing electronic documents. The user interface includes a list of incoming electronic XML documents 40 (NF-e) in the top half of the interface with the first such document selected and highlighted. The bottom half of the interface includes the processing steps 75 to be executed for the selected XML document 40 as well as the status of each of the processing steps 75.

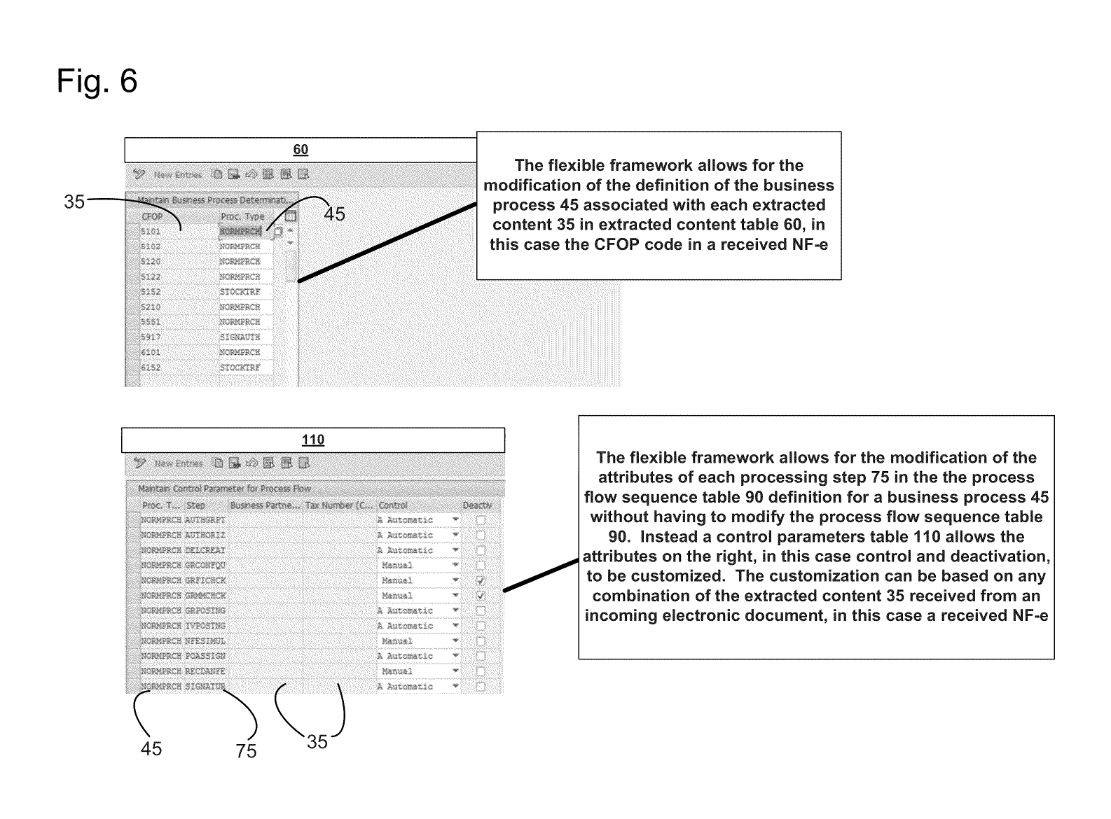

FIG. 6 shows examples of a user interface for the system 10 for processing electronic documents. The user interface includes an extracted content table 60 which defines an associated business process 15 for each of the at least one extracted content 35 of the XML document 40 in the top half of the interface with the first associated business process 15 selected and highlighted. The bottom half of the interface includes a control parameters table 110 that allows users to influence the processing steps 75. Depending on the at least one extracted content 35, for example the business partners or tax number associated with business process 45, the execution of a processing step 75 can be defined as automatically or manually implemented or can be deactivated, for example for a certain combination of business partners.

Shown below are schematic displays of example extracts of some of the tables used in an example business process 45: ‘Normal Purchasing’.

Process flow sequence table 90 used to define the sequence and certain attributes of the processing steps 75 associated with business process 45: ‘Normal Purchasing’:

| | | Auto- | |
|---|---|---|---|
| | | matic | Step |
| | Step | pro- | deacti- |
| Description of the Step | number | cessing | vated |
| Check the signature of the legal document | 10 | Yes | No |
| Check the authorization of the legal | 20 | Yes | No |
| document | | | |
| Assign related purchase order items | 30 | Yes | No |
| Simulate postings to be done in the ERP | 40 | Yes | No |
| system to check if the process can be | | | |
| completed using the assigned purchase order | | | |
| Trigger the creation of a delivery in the ERP | 50 | Yes | No |
| system based on the assigned purchase order | | | |
| Inform the vendor to start the transport of | 60 | Yes | No |
| the goods | | | |
| Arrival of the goods and recording of the | 70 | No | No |
| accompanying document | | | |
| Check if the legal document is still | 80 | Yes | No |
| authorized | | | |
| Counting and controlling of the goods | 90 | No | No |
| Get the confirmation to accept the goods | 100 | No | No |
| Prepare the posting of the goods receipt | 110 | No | No |
| Post the goods receipt in the ERP system | 120 | Yes | No |
| Post the invoice receipt and the | 130 | Yes | No |
| corresponding legal document in the ERP | | | |
| system | | | |

As shown above, some of the processing steps 75 are defined to be executed automatically and others need a user interaction and therefore are not automatic. In the above example all the steps are defined to be active. However, some of the processing steps 75 can be deactivated if they are not mandatory for business process 45: ‘Normal Purchasing’ as per the definition of each processing step 75 in process steps table 80. To deactivate processing steps 75 that are not mandatory the control parameters table 110 can be used.

For example, if the steps shown below are not mandatory for business process 45: ‘Normal Purchasing’, as per the definition of each processing step 75 in process steps table 80, then control parameters table 110 could be used to influence the sequence (of process flow sequence table 90 above) as shown below:

| | Business | Business | | |
|---|---|---|---|---|
| Description | Partner | Partner | Automatic | Step |
| of the Step | Sender | Receiver | processing | deactivated |
| Counting and | 74544297000435 | | No | Yes |
| controlling of | | | | |
| the goods | | | | |
| Get the | 74544297000435 | | No | Yes |
| confirmation | | | | |
| to accept | | | | |
| the goods | | | | |
| Prepare the | 74544297000435 | | No | Yes |
| posting of | | | | |
| the goods | | | | |
| receipt | | | | |

Furthermore, the control parameters table 110 can change the settings of the process flow sequence for some steps depending on the business partners. As shown above, tax numbers are used which identify a business partner that may be involved in business process 45: ‘Normal Purchasing’.

A control process flow table 100 defines the pre requisites necessary before implementing each processing step 75 in business process 45: ‘Normal Purchasing’, for example by defining which status of the preceding or subsequent steps are necessary to carry out a certain processing step 75 as shown below:

| Processing step to be | |
|---|---|
| executed | Prerequisites for the processing step |
| Assign related purchase order | Can be executed if: |
| items (step number 30) | the authorization check in step 20 was |
| | successful and there is no delivery created |
| | so far (step 50) because the delivery |
| | creation is based on the assigned |
| | purchase order and therefore the |
| | assignment should not be changed |
| | anymore once the delivery was created |
| Post the invoice receipt and | Can be executed if: |
| the corresponding legal | the step itself was not yet executed or |
| document in the ERP system | the step itself was already executed but |
| (step 130) | with an error so that you can retry posting |
| | after correction of the error and step |
| | 120 for posting the goods receipt was |
| | carried out successfully. |

As shown below, process steps table 80 can be used to define the implementation of the processing steps 75 and the step attributes, for example the processing steps 75 shown below are defined as being implemented in the function module 120 of GRC system 30:

| | Imple- | Can be | Can be | |
|---|---|---|---|---|
| Description of the | mentation | executed | executed | Can be |
| step | of the step | manually | automatically | deactivated |
| Check | function | No | Yes | Yes |
| Authorization | module | | | |
| After NF-e | | | | |
| Receipt | | | | |
| Assign Purchase | function | Yes | Yes | Yes |
| Order Items | module | | | |
| Post the invoice | function | No | Yes | No |
| receipt and the | module | | | |
| corresponding | | | | |
| legal document | | | | |
| in the ERP | | | | |
| system | | | | |

Embodiments of the present invention are described in the context of a fully functional computer system, however those skilled in the art will appreciate that modules of the present invention are capable of being distributed in a variety of forms across a plurality of systems. Embodiments consistent with the invention may also include one or more programs or program modules on different computing systems running separately and independently of each other, while in their entirety being capable of performing business transactions in a large enterprise environment or in a “software on demand” environment. These programs or program modules may be contained on signal bearing media that may include: recordable type media such as floppy disks and CD ROMS, and transmission type media such as digital and analog communication links, including wireless communication links.

The foregoing description is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A method for processing electronic documents with business systems, comprising:
receiving at least one electronic document in a control system connected to at least one business system;
extracting contents from the at least one electronic document according to an extraction table in the control system, wherein the extraction table defines the contents to be extracted for each type of electronic document that is processed;
determining a business process to be implemented, from a plurality of business processes defined in a business processes table in the control system, based on a comparison of at least one of the extracted contents to an extracted content table in the control system, wherein the extracted content table defines an associated business process for each of the at least one extracted contents;
determining a sequence of processing steps, from a plurality of processing steps defined in a process steps table in the control system, based on a comparison of the determined business process to a process flow sequence table in the control system, wherein the process flow sequence table defines the sequence of processing steps for each business process; and
implementing the sequence of processing steps according to a control process flow table in the control system, wherein the control process flow table defines pre-requisites for implementing a next processing step in the sequence of processing steps for each business process.

2. The method of claim 1, wherein the at least one electronic document is n XML document.

3. The method of claim 1, wherein the at least one extracted contents used for the comparison to an extracted content table includes tax code information.

4. The method of claim 1, wherein the sequence of processing steps for a business process can be altered based on a comparison of at least one of the extracted contents to a control parameters table in the control system.

5. The method of claim 4, wherein the at least one extracted contents used for the comparison to the control parameters table includes at least one of a) business partner information, and b) tax code information.

6. The method of claim 4, wherein the alteration of the sequence of processing steps for a business process includes at least one of a) a processing step being defined as automatic or manual, and b) a processing step being deactivated or reactivated.

7. The method of claim 1, wherein the process steps table defines attributes for each process step including at least one of a) whether the processing step is optional or mandatory within each business process, b) whether the processing step can be carried out automatically or also manually, and c) whether the processing step can be deactivated.

8. The method of claim 1, the prerequisites for each processing step includes checking whether previous processing steps in the sequence of processing steps have been implemented.

9. The method of claim 1, wherein the prerequisites for each processing step includes checking at least one of a) whether the processing step can be executed automatically, and b) whether the processing step is deactivated.

10. The method of claim 1, wherein the implementation of a processing step in the sequence of processing steps for each business process is implemented in either the at least one business system or the control system based on the definition of the processing step in the process steps table.

11. The method of claim 10, wherein if the control system is connected to a plurality of business systems and the implementation of a processing step in the sequence of processing steps for a business process is defined as being implemented in at least one business system then the business system in which the processing step is implemented is determined based on at least one of the extracted contents.

12. The method of claim 1, wherein the implementation of the sequence of processing steps for each business process is stopped and automatically continued at a later time if there is an error or if a step cannot be implemented automatically.

13. A computer-readable medium having stored thereon instructions adapted to be executed by a processor, the instructions which, when executed, cause the processor to perform a method for processing electronic documents with business systems, comprising:
receiving at least one electronic document in a control system connected to at least one business system;
extracting contents from the at least one electronic document according to an extraction table in the control system, wherein the extraction table defines the contents to be extracted for each type of electronic document that is processed;
determining a business process to be implemented, from a plurality of business processes defined in a business processes table in the control system, based on a comparison of at least one of the extracted contents to an extracted content table in the control system, wherein the extracted content table defines an associated business process for each of the at least one extracted contents;
determining a sequence of processing steps, from a plurality of processing steps defined in a process steps table in the control system, based on a comparison of the determined business process to a process flow sequence table in the control system, wherein the process flow sequence table defines the sequence of processing steps for each business process; and
implementing the sequence of processing steps according to a control process flow table in the control system, wherein the control process flow table defines pre-requisites for implementing a next processing step in the sequence of processing steps for each business process.

14. A system for processing electronic documents with business systems, comprising:
at least one business system including a processor; and
a control system including a processor and connected to the at least one business system, the control system configured to:
receive at least one electronic document;
extract contents from the at least one electronic document according to an extraction table in the control system, wherein the extraction table defines the contents to be extracted for each type of electronic document that is processed;
determine a business process to be implemented, from a plurality of business processes defined in a business processes table in the control system, based on a comparison of at least one of the extracted contents to an extracted content table in the control system, wherein the extracted content table defines an associated business process for each of the at least one extracted contents;
determine a sequence of processing steps, from a plurality of processing steps defined in a process steps table in the control system, based on a comparison of the determined business process to a process flow sequence table in the control system, wherein the process flow sequence table defines the sequence of processing steps for each business process; and
implement the sequence of processing steps according to a control process flow table in the control system, wherein the control process flow table defines pre-requisites for implementing a next processing step in the sequence of processing steps for each business process.

15. The system of claim 14, wherein the at least one extracted contents used for the comparison to an extracted content table includes tax code information

16. The system of claim 14, wherein the sequence of processing steps for a business process can be altered based on a comparison of at least one of the extracted contents to a control parameters table in the control system.

17. The system of claim 16, wherein the at least one extracted contents used for the comparison to the control parameters table includes at least one of a) business partner information, and b) tax code information,

18. The system of claim 16, wherein the alteration of the sequence of processing steps for a business process includes at least one of a) a processing step being defined as automatic or manual, and b) a processing step being deactivated or reactivated.

19. The system of claim 14, the prerequisites for each processing step includes checking whether previous processing steps in the sequence of processing steps have been implemented.

20. The system of claim 14, wherein the implementation of a processing step in the sequence of processing steps for each business process is implemented in either the at least one business system or the control system based on the definition of the processing step in the process steps table.
